(19) United States
(12) Patent Application Publication
(10) Pub. No.: US 2008/0250689 A1
(43) Pub. Date: Oct. 16, 2008

(54) Seeded Hangtag

(76) Inventor: Stacey Cohen, New York, NY (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/735,271

(22) Filed: Apr. 13, 2007

(51) Int. Cl. G09F 3/14

(52) U.S. Cl. 40/664; 40/672; 47/56

(57) ABSTRACT

A hangtag is provided wherein the hangtag material has viable seeds embedded therein or attached thereto so that, when the hangtag is planted, the seeds can grow to produce plants and preferably flowers. Also provided are methods of making and planting the hangtag.

### BACKGROUND OF THE INVENTION

The present invention relates generally to the field of hangtags, and particularly, to hangtags having viable seeds embedded therein or attached thereto.

Consumers desire to be associated with environmental causes, the idea of freedom, and making the world a better place. Young consumers, in particular, find these ideas appealing and see flowers and plants as a way of expressing their ideals and beliefs. While these same consumers are also interested in clothing and other items, plants and flowering plants are only expressed figuratively through images or descriptions on such items. Further, hangtags typically display size, price and retailer information, but they generally lack any intrinsic value beyond the information they provide. Accordingly, there is a need or desire for a hangtag having viable seeds embedded therein or attached thereto that can be planted to grow plants and flowering plants in order to allow consumers to express their support for environmental causes.

### SUMMARY OF THE INVENTION

A hangtag is provided wherein the hangtag material has viable seeds embedded therein or attached thereto so that, when the hangtag is planted, the seeds can grow to produce plants and preferably flowering plants. Also provided are methods of making and planting a seeded hangtag.

### BRIEF DESCRIPTION OF THE DRAWINGS

FIG. 1A is a perspective view of a seeded hangtag in accordance with the present invention.

FIG. 1B is a front view of the hangtag of FIG. 1.

FIG. 1C is a back view of the hangtag of FIG. 1.

FIG. 2 is a perspective view of another aspect of the hangtag in accordance with the present invention.

FIG. 3 depicts the hangtag of FIG. 1 attached to an article of clothing.

FIG. 4 is a perspective view of another aspect of a hangtag in accordance with the present invention, depicting it folded: (a) in a predominately closed position and (b) in a predominately opened position.

### DETAILED DESCRIPTION OF THE PREFERRED EMBODIMENTS

While the construction and use of preferred embodiments is discussed in detail below, it will be appreciated that the specific embodiments described do not limit the scope of the invention.

The present invention relates to a hangtag that is made of a seeded material that a consumer can plant in order to grow flowers and plants from seeds contained in the material or has seeds attached thereto.

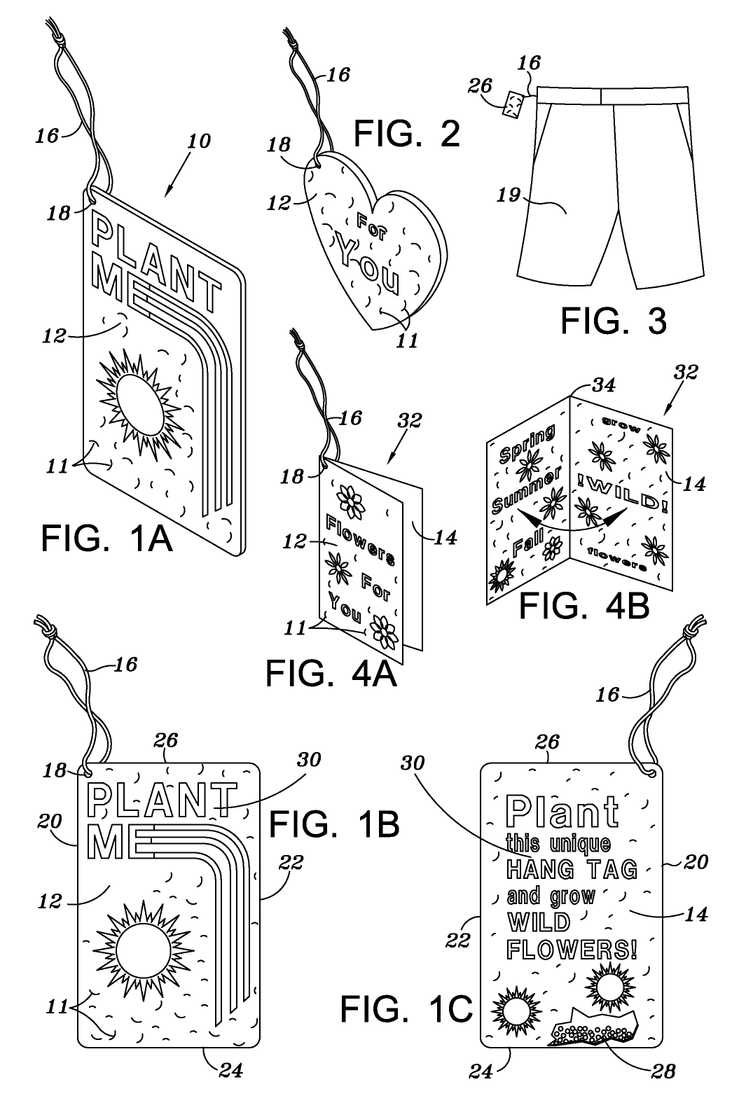

FIG. 1A shows a hangtag in accordance with the present invention. Hangtag 10 having at least one seed 11 embedded therein has a front 12 and in one form is rectangular, as shown, but it can be any shape. A particularly desirable shape is that of a heart as shown in FIG. 2. A strip of material 16 is looped through hangtag 10 through at least one aperture 18 so the strip can be fastened to an article of clothing 19, as shown in FIG. 3, or some other item. The term “clothing” as used herein applies generally to wearable items.

FIGS. 1B and 1C more particularly show hangtag 10 in front and back view, respectively, with front surface 12 and back surface 14 and first side 20 and second side 22, bottom 24 and top 26. One or more seeds 11 may be dispersed throughout the material, and the material may be printed with various messages 30 such as advertising, instructions, slogans, or any other information that is useful or desirable to a consumer. In preferred application, hangtag 10 is printed with an environmentally-friendly ink.

Referring to FIG. 1C, in addition to one or more seeds embedded within the hangtag, hangtag 10 may also have seeds attached in a pocket 28 or similar structure, preferably transparent but not necessarily, and preferably at least partially degradable, wherein seeds are provided with the hangtag for planting. In this aspect, hangtag 10 may or may not have one or more seeds embedded therein

FIGS. 4A and 4B show hangtag 10 in folded position 32. Folded hangtag 32 is preferably folded along one vertical fold line 34, however multiple folds, in a variety of orientations, is contemplated (not shown). FIG. 4A depicts folded hangtag 32 in its mostly closed position showing that the hangtag may be printed on front surface 12, and FIG. 4B shows hangtag 32 in a mostly opened position showing that it may be optionally printed on back surface 14. It is also contemplated that folding hangtag 32 is multi-folded, with multiple parallel or non-parallel fold lines, in a manner attractive to a consumer.

Hangtag 10 or 32 is made from one or more materials that comprise one or more viable seeds. The materials may be any durable, but at least partially degradable, materials, and may be either synthetic or natural, although natural materials are highly preferred. Partially or fully degradable materials permit the seeds to germinate and grow in the presence of moisture or other applicable degrading means. Of natural materials, cellulosic fibers such as wood and cotton are preferred and are known to degrade in the presence of moisture and light. Such natural materials are typically referred to as paper but may also include synthetic materials as used herein.

To make the seeded material, the material may be dissolved in solvent such as water, other solvent, or any suitable degrading means to dissolve the material, and mixed with viable seeds. The solvent/degrading means should not compromise the viability of the seeds. Fertilizers and plant food, or other growth promoters, may be added during processing for incorporation into the hangtag. Organic fertilizers derived from carbon sources are particularly preferred, and include those derived from peat or mineral deposits or made through composting. The fertilizers, either organic or not, preferably provide at least nitrogen, phosphorus, and potassium and may also provide calcium, sulfur, magnesium. Trace elements (micronutrients) may also be included. The proportions of the nutrients contained in the fertilizer should be suited to the seed (or seeds) embedded in or attached to the hangtag. Growth promoters may include hormones and protein-based materials, as well as the compounds already mentioned, depending upon the source and the use of the compounds as known to one of ordinary skill in the art of plant development. Seeds of varying sizes and shapes are suitable depending on the form of the hangtag sought, for instance, a thicker hangtag can have a thicker seed and a thinner hangtag would have a thinner seed in order to prevent the seed from tearing the material, although it is recognized that this may be desired in a particular application. Seeds of flowering plants are particularly preferred for incorporation into the material. The material and seed mixture is dried and formed into any desired shape, as mentioned previously.

Hangtag 10 or 32, or any means of identifying a product having seeds embedded therein or attached thereto, for instance, a label, may be attached to any article. Hangtag 10 or 32 or any seeded hangtag in accordance with the present invention may be used in a preferred approach to promote an article, for instance, by providing a seed for a plant or flower of a same or similar them as the promoted article. For example, a seeded hangtag may have one or more seeds for daisies attached to media, such as a digital video disc (DVD) or book, containing a copy of a movie titled “Daisies” or a title that evokes the thought of image of daisies. But such use is not limited to merely media. As another instance, a seeded hangtag could also be used to promote the sale of linens (e.g. bedding, clothes, etc.) by having a hangtag embedded with one or more cotton seeds. Or, further, cereal could be promoted by including a hangtag containing one or more seeds for wheat which may be particularly suitable to raise a consumer's awareness of environmental issues. Similarly, grocery produce, either fresh or packaged, particularly organic produce, may have a seeded hangtag attached having one or more seeds for the sold produce (e.g., peas, carrots, strawberries, oranges, apples, onions, tomatoes, squash, broccoli, cauliflower, lettuce, cabbage, spinach, garlic, rosemary, thyme, sage, oregano, blueberries, cherries, boysenberries, mango, papaya, pineapple, etc.) or having seeds for a related item or multiple items. As an example, a canned vegetable have may have a seeded hangtag for that or related vegetable, or for an herb, attached. Additionally, for example, a seeded hangtag may include seeds for onions and tomatoes attached to a package containing hamburger. A vast number of possibilities exist and the examples above are not meant to limit the scope of the invention but are provided to illustrate the multiple possibilities.

Hangtag 10 or 32 can be removed from the article and planted in a variety of settings at the user's discretion, and it is contemplated to include indoor or outdoor environments. Basically, the hangtag can be planted anywhere a consumer wants to grow flowers and plants, such as pots, gardens, flower beds, yards and the like where plants are generally grown. It is acceptable, and depending upon the environment, preferable, that at least one fertilizer or plant food or both are also provided when hangtag 10 is planted to foster the development and growth of seed 11.

The specific embodiments discussed herein are merely illustrative of specific ways to make and use the invention, and do not delimit the scope of the invention. Those skilled in the art will recognize that various substitutions and modifications may be made to the invention without departing from the scope and spirit of the appended claims.

1. A hangtag for apparel capable of removal and planting comprising a material having at least one viable seed embedded therein attached to an article of clothing.

2. The hangtag of claim 1, wherein said material is made of at least partially degradable materials.

3. The hangtag of claim 1, wherein said material is at least partially comprised of at least one natural material.

4. The hangtag of claim 1, wherein said material contains at least one compound that encourages germination and growth of said at least one seed.

5. The hangtag of claim 4, where said compound is a fertilizer or plant food.

6. The hangtag of claim 1, wherein said material is printed with information useful to a consumer.

7. The hangtag of claims 1 or 6, wherein said material is attached to said article by a connecting member.

8. The hangtag of claim 7, wherein said connecting member is flexible.

9-15. (canceled)

16. A seeded hangtag for apparel for planting comprising:
a hangtag with at least one viable seed embedded therein having front and back surfaces, at least three sides and comprised of at least partially degradable printable material; and
said hangtag further being attachable to an article of clothing.

17. The hangtag of claim 16, wherein said hangtag is substantially rectangular.

18. The hangtag of claim 16, wherein said hangtag is capable of having printed information on at least one of said front and back surfaces.

19. The hangtag of claim 16, wherein said hangtag has at least one aperture for attachment by a connector extending therethrough to an article of clothing.

20. A hangtag for apparel capable of removal and planting comprising:
a substantially rectangular hangtag with at least one seed embedded therein having front and back surfaces, first and second sides, and top and bottom sides;
said hangtag having printed information on at least one of said front and back surfaces;
said hangtag comprised of at least partially degradable printable material; and
said hangtag further having at least one aperture for attachment to an article of clothing by a connector extending therethrough.

21. The hangtag of claim 20, wherein said at least one aperture is near the perimeter of said hang tang.

22. The hangtag of claim 21, wherein said at least one aperture is near a corner formed by said top side and at least one of said first and second sides.

23-28. (canceled)

29. A promotional item, comprising:
an item of interest to a consumer;
a hangtag at least one viable seed embedded therein;
wherein said hangtag is attached to said item.

30. The promotional item of claim 29, wherein said at least one seed relates to said item of interest.

31. The promotional item of claim 30, wherein said item of interest and said at least one seed both relate to flowers.

32. The promotional item of claim 30, wherein said item of interest and said at least one seed both relate to vegetables.

33. The promotional item of claim 30, wherein said item of interest and said at least one seed both relate herbs.

34. The promotional item of claim 30, wherein said item of interest and said at least one seed both relate to flowers.

35. The promotional item of claim 30, wherein said item of interest is a product at least partially made from at least one plant of the same genus as said at least one seed.

36. The promotional item of claim 30, wherein said item of interest is a product derived from a source different than a plant sharing the same genus as said at least one seed.

37. The promotional item of claim 29, wherein said item of interest is print or electronic media.

38-40. (canceled)

41. A promotional item, comprising:
an item of interest to a consumer;
a separate hangtag having at least one viable seed embedded therein being thematically related to said item of interest;
wherein said hangtag is attached to said item by a strip of material.

42. The promotional item of claim 41, wherein said item of interest is a DVD or book having the title or directly relating to one or more of an herb, flower or vegetable.

43. The promotional item of claim 41, wherein said item of interest is an article manufactured substantially from material from a seed of one or more of an herb, flower or vegetable and said at least one viable seed embedded within said hangtag corresponds to said herb, flower or vegetable.

44. The promotional item of claim 43, wherein said item of interest is a product comprising cotton linen and said at least one viable seed is cotton seed.

45. The promotional item of claim 43, wherein said item of interest is a consumable wheat cereal product and said at least one viable seed is wheat seed.

46. The promotional item of claim 41, wherein said item of interest is a canned product consisting essentially of a vegetable and said at least one viable seed is a seed of that vegetable.
